(19) United States
(12) Patent Application Publication
(10) Pub. No.: US 2022/0251867 A1
(43) Pub. Date: Aug. 11, 2022

(54) Interactive Memorial Assembly and System

(71) Applicant: Mykiea Miller, Mobile, AL (US)

(72) Inventor: Mykiea Miller, Mobile, AL (US)

(21) Appl. No.: 17/354,952

(22) Filed: Jun. 22, 2021

Related U.S. Application Data
(60) Provisional application No. 63/147,364, filed on Feb. 9, 2021.

(51) Int. Cl. E04H 13/00; H04N 7/18; H04N 5/232; G06F 3/041; G06F 3/14; H04R 1/02; H04R 3/00; H02S 40/38

(52) U.S. Cl. CPC E04H 13/003; H04N 7/183; H04N 5/23203; H04N 5/23299; H04L 67/12; G06F 3/14; H04R 1/028; H04R 3/00; H02S 40/38; G06F 3/041

(57) ABSTRACT

An interactive memorial assembly adapted to interact with a user and a system of use. The interactive memorial assembly comprises a commemorative marker body and a display component integrated into or attached to the commemorative marker body. The display component is configured for accessibility by a user to access or upload digital content related to a decedent. The interactive memorial assembly is solar powered and connectable to the Internet. The system connects the interactive memorial assembly to a server via a network that is accessible via a mobile Application using a mobile electronic device. An interactive memorial platform on the system allows for remote access to the interactive memorial assembly.

### CROSS-REFERENCE TO RELATED APPLICATION

The present application claims priority to, and the benefit of, U.S. Provisional Application No. 63/147,364, which was filed on Feb. 9, 2021 and is incorporated herein by reference in its entirety.

### FIELD OF THE INVENTION

The present invention generally relates to a memorial assembly for decedents, and more specifically to an interactive digital memorial tombstone assembly adapted to interact with a user. Accordingly, the present specification makes specific reference thereto. However, it is to be appreciated that aspects of the present invention are also equally amenable to other like applications, devices, and methods of manufacture.

### BACKGROUND OF THE INVENTION

Traditional tombstones or grave markers are uninspiring and susceptible to extreme wear due to inclement weather and other environmental conditions. Funeral ceremonies often include images such as photographs or videos of the loved one as a way to remember and honor the deceased. However, once the funeral or memorial service is over, these displays are no longer readily available. Once the funeral is over, there is no easy way to continue celebrating the life or remembering the decedent's life. People quickly forget what a deceased loved one looks and sounds like. Tombstones are typically unmonitored and may be vulnerable to damage or vandalism.

Gravestones often have text engraved upon to briefly explain who the deceased was and when he or she died. There is limited space large on the tombstone to provide any details about the decedent. The loved one may become forgotten with only a name and date to indicate anything about them. Conventional gravestones are easily lost among many similar markers all located in a cemetery which may extend over a large area. There is no easy way to locate a specific gravesite without specific directions.

Accordingly, there is a great need for an interactive way for people to relate to a decedent after they have passed. There is also a need for a way for a convenient way to access information about a decedent. Similarly, there is a need for a way for individuals to share information about a decedent for access later at any time. There is also a need for a digital platform for individuals to access messages, pictures, or videos of the decedent on demand. Further, there is a need for a way to easily locate a gravesite. Finally, there is a need for a way to monitor a gravesite remotely.

In this manner, the improved commemorative system of the present invention accomplishes all of the forgoing objectives, thereby providing an easy solution for allowing people to interact with a memorial. A primary feature of the present invention is an interactive memorial assembly configured to allow users to relate to and remember a decedent. The present invention allows a person to easily locate a gravesite in a cemetery or other place of internment. Additionally, the interactive memorial assembly allows users to view photographs and videos of the decedent. Finally, the interactive memorial assembly is remotely accessible for commemorating the decedent and monitoring their place of internment.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an interactive memorial assembly. The interactive memorial assembly allows users to digitally memorialize a decedent in a traditional tombstone configuration. The interactive memorial assembly comprises a commemorative marker body, a display component, and a power component. The commemorative marker body comprises a front side, a back side and a top.

The display component is integrated into or attached to the front side of the commemorative marker body. The display component is in electrical communication with the power component and comprises a touchscreen, a user input, a processor, and a memory. The display component is configured to display digital content related to the decedent storable in the memory. The user input is configured to allow a user to access stored digital content and to upload additional digital content. The display component may further comprise a communication link operatively coupled to the processor and the memory for remotely accessing the interactive memorial assembly.

The interactive memorial assembly may further comprise an audio component. The audio component may be a speaker operatively connected to the display component to provide audio related to the digital content. The interactive memorial assembly may further comprise a monitoring component. The monitoring component may comprise a 360 degree rotating digital camera attachable to the top of the commemorative marker body. The monitoring component is in electrical communication with the display component and the power component.

The power component comprises a plurality of solar cells and a rechargeable battery integrated into the commemorative marker body. The plurality of solar cells are attachable to the back or the sides of the commemorative marker body. The interactive memorial assembly may further comprise a global positioning component. The global positioning component is attachable to or integrated into the commemorative marker body.

The subject matter disclosed and claimed herein, in one embodiment thereof, comprises an interactive memorial system. The interactive memorial system is accessible via a mobile electronic device. The interactive memorial system is configured to digitally memorialize a person on a platform that is remotely accessible over the Internet. The interactive memorial system provides users access to an interactive memorial platform from a remote location, such as a grave site or other place of internment.

The interactive memorial system comprises a server. The server comprises at least one processor and an interactive memorial platform. The server further comprises a memory. The memory comprises a non-transitory computer-readable medium comprising a set of software instructions. A mobile application is hosted on the mobile electronic device and is used to connect to and access the interactive memorial platform via a network.

The interactive memorial platform is configured to allow a user to access an interactive memorial assembly remotely. The interactive memorial platform is further configured to locate the interactive memorial assembly remotely via global positioning. The interactive memorial platform is further configured to upload, and access digital content related to a decedent. The interactive memorial platform is further configured to artificially age any uploaded digital content.

The interactive memorial assembly comprises a commemorative marker body, a display component, and a power component. The display component is integrated into or attached to the commemorative marker body. The display component is in electrical communication with the power component and comprises a touchscreen, a user input, a processor, and a memory. The display component is configured to display digital content related to the decedent storable in the memory or on the interactive memorial platform. The user input is configured to allow a user to access stored digital content and to upload additional digital content to the memory or the interactive memorial platform. The display component may further comprise a communication link operatively coupled to the processor and the memory for remotely accessing the interactive memorial assembly via the mobile application.

The interactive memorial assembly may further comprise an audio component. The audio component may be a speaker operatively connected to the display component to provide audio related to the digital content. The interactive memorial assembly may further comprise a monitoring component. The monitoring component may comprise a 360 degree rotating digital camera attachable to the top of the commemorative marker body. The monitoring component is in electrical communication with the display component and the power component. The interactive memorial platform is further configured to remotely access and reposition the monitoring component.

The power component comprises a plurality of solar cells and a rechargeable battery integrated into the commemorative marker body. The plurality of solar cells are attachable to the commemorative marker body. The interactive memorial assembly may further comprise a global positioning component. The global positioning component is attachable to or integrated into the commemorative marker body. The global positioning component is accessible by the interactive memorial platform so that the user can locate the interactive memorial assembly via the mobile application.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an interactive memorial assembly of the present invention in accordance with the disclosed architecture.

FIG. 2 illustrates a rear perspective view of the interactive memorial assembly of the present invention in accordance with the disclosed architecture.

FIG. 3 illustrates front perspective view of the interactive memorial assembly of the present invention in accordance with the disclosed architecture.

FIG. 4 illustrates a schematic view of a display component of the interactive memorial assembly of the present invention in accordance with the disclosed architecture.

FIG. 5 illustrates an exemplary system environment of an embodiment of an interactive memorial system of the present invention in accordance with the disclosed architecture.

FIG. 6 illustrates a schematic view of an interactive memorial platform of the interactive memorial system of the present invention in accordance with the disclosed architecture.

FIG. 7 illustrates a perspective view of a user accessing an interactive memorial assembly of the interactive memorial system of the present invention using a mobile electronic device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, provides users with an improved, durable tombstone or grave marker that is wirelessly connectable to a smart phone application. The tombstone or grave marker is designed to monitor and honor a loved one's final resting place. The tombstone or grave marker may be transparent, translucent, or partially transparent, and may be manufactured from strong, durable glass or plastic materials. The tombstone or grave marker is configured to allow a plurality of users to upload digital imagery and video to the tombstone or grave marker via a touchscreen display or through the application. The application is configured to alter digital images to show how the decedent could have naturally aged over time had they lived longer.

The tombstone or grave marker may comprise a plurality of solar panels installable to the sides or back of the tombstone or grave marker to consistently generate and maintain power to the tombstone or grave marker. A battery may be used to store power. The tombstone or grave marker comprises a camera configured to view up to 360 degrees. The camera is attachable to a top of the tombstone or grave marker and is accessible via the application. A GPS locator may be used to view the location of the tombstone or grave marker through the application and is configured to share the location with other users.

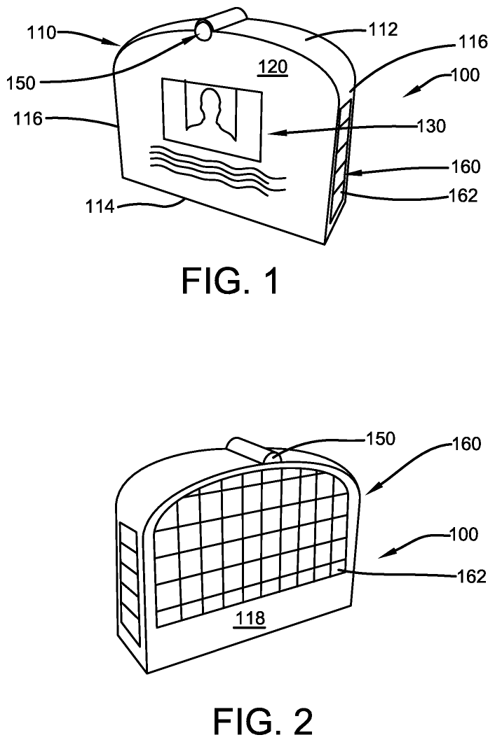

Referring initially to the drawings, FIGS. 1-4 illustrate an interactive memorial assembly 100. As illustrated in FIG. 1, the interactive memorial assembly 100 comprises a commemorative marker body 110. The commemorative marker body 110 may be a tombstone, gravestone, grave marker, crypt, mausoleum, or any other permanent memorial indicator to mark a final place of internment. The commemorative marker body 110 may be constructed of glass, stone natural material, composite materials, cork, bamboo, wood, hemp, wool, linen, straw, clay, stone, sand, beeswax, coconut, or any sustainable material. The commemorative marker body 110 may be translucent, transparent, reflective, or opaque. As illustrated in FIGS. 1-3, the commemorative marker body 110 comprises a top 112, a bottom 114, a pair of lateral sides 116, a front side 120, and a back side 118.

The interactive memorial assembly 100 further comprises a display component 130 and a power component 160. The display component 130 is integrated into or attached to the front side 120 of the commemorative marker body 110. The display component 130 is waterproof or otherwise sealed into the commemorative marker body 110 for protection from the elements. The display component 130 comprises a touch screen 136. The touch screen 136 may be any interactive digital screen or digital display.

The display component 130 is in electrical communication with the power component 160 and further comprises a user input 138, a processor 132, and a memory 134 as illustrated in FIG. 4. The display component 130 is configured to display digital content on the touchscreen 136 related to the decedent that is storable in the memory 134. The user input 138 is configured to allow a user to access stored digital content and to upload additional digital content to the display component 130. The user input 138 may be integrated into the touchscreen 136 or be a separate input. The memory 134 comprises a non-transitory computer-readable medium comprising a set of software instructions. The display component 130 may further comprise a communication link 140 operatively coupled to the processor 132 and the memory 134 for remotely accessing the interactive memorial assembly 100 as discussed infra.

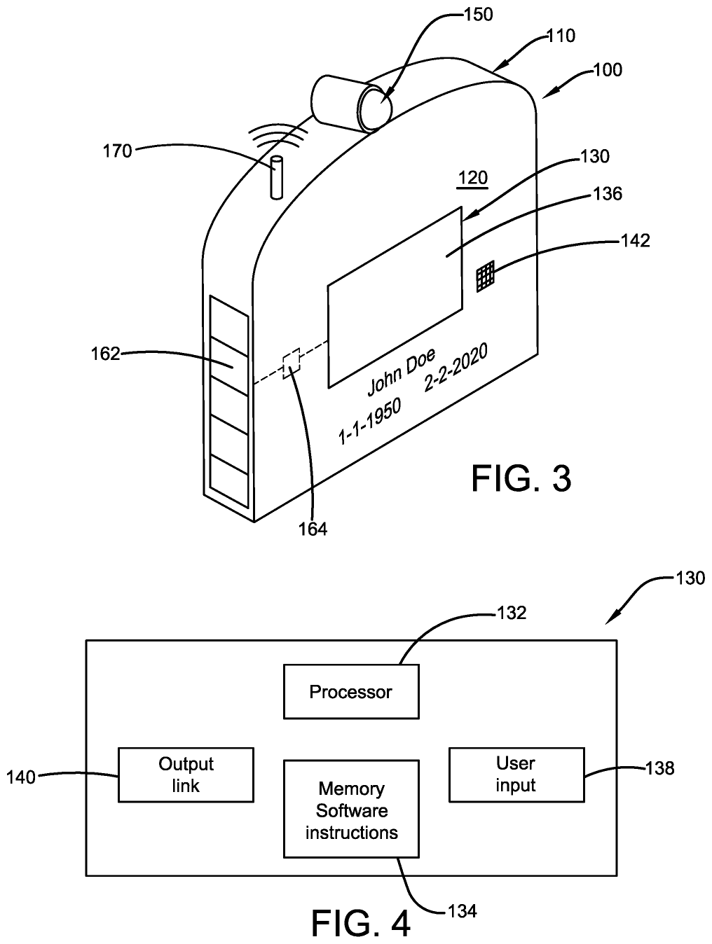

The interactive memorial assembly 100 may further comprise an audio component 142 as illustrated in FIG. 3. The audio component 142 may be one or more speakers operatively connected to the display component 130 to provide audio related to the digital content stored in the memory 134. The audio component 142 may have Wi-Fi or Bluetooth® connectivity that is compatible with wireless speakers, sound systems, headphones, or earbuds that pairs through the mobile application. The interactive memorial assembly 100 may further comprise a monitoring component 150. The monitoring component 150 may comprise a 360 degree rotating digital camera attachable to the top 112 of the commemorative marker body 110. The monitoring component 150 is in electrical communication with the display component 130 and the power component 160.

The power component 160 comprises a plurality of solar cells 162 and a rechargeable battery 164. The battery 164 is typically integrated into the commemorative marker body 110. The plurality of solar cells 162 are attachable to the back 118 or the sides 116 of the commemorative marker body 110, although they can be attached anywhere where it would be advantageous. The interactive memorial assembly 100 may further comprise a global positioning component 170. The global positioning component 170 is typically a GPS chip or transmitter that is attachable to or integrated into the commemorative marker body 110. The global positioning component 170 is powered by the power component 160.

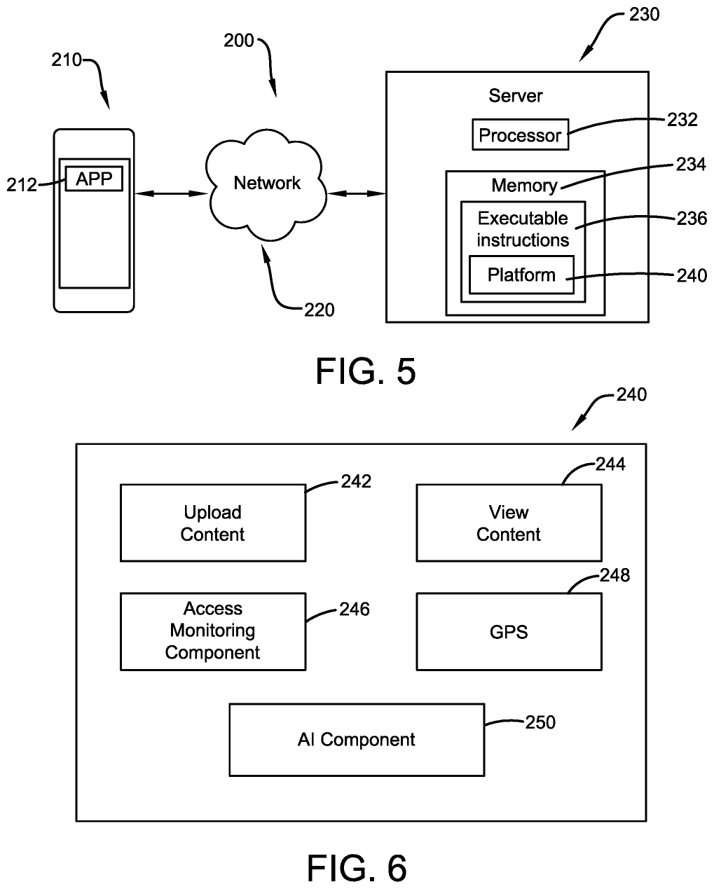

The subject matter disclosed and claimed herein, in one embodiment thereof, comprises an interactive memorial system 200. As illustrated in FIGS. 5-7, the interactive memorial system 200 is accessible via a mobile electronic device 210. The interactive memorial system 200 is configured to digitally memorialize a person on a platform that is remotely accessible over the Internet. The interactive memorial system 200 provides users access to an interactive memorial platform 100 from a remote location, such as a grave site or other place of internment.

As illustrated in FIG. 5, the interactive memorial system 200 further comprises a server 230. The server 230 comprises at least one processor 232 and a memory 234. The memory 234 comprises a non-transitory computer-readable medium comprising a set of software instructions 236. The set of software instructions 136 comprises an interactive memorial platform 240 stored on the server 230 in the memory 234. The server 230 is operatively connectable to the mobile electronic devices 210 via a communications network 120. The communications network 120 may be any of a number of private or public communications mechanisms such as the Internet, a local intranet, a Personal Area Network, a Local Area Network, a Wide Area Network, a Virtual Private Network, or the like. When one of the mobile electronic devices 210 is connected to the server 230 via the network 220, the interactive memorial platform 140 allows the server 130 to perform methods of the present technology when executed by the processor 132

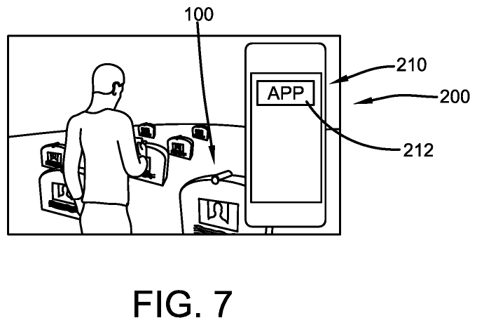

As illustrated in FIG. 7, a mobile application 212 is hosted on the mobile electronic device 210 and is also used to connect to and access the interactive memorial platform 240 via the network 220. The mobile application 212 allows the mobile electronic device 210 to perform methods of the present technology when executed. The mobile electronic device 210 may be a mobile electronic device or other internet connectable user input, such as a smart phone, an electronic pad, a computer, a smart watch, a digital assistant, or any other internet connected communication device.

The interactive memorial platform 240 is configured to allow a user to access an interactive memorial assembly 100 remotely. As illustrated in FIG. 6, the interactive memorial platform 240 comprises a content upload component 242 and a content viewing component 244 respectively configured to upload, and access digital content related to a decedent. The interactive memorial platform 240 further comprises a position locating component 248 configured to locate the interactive memorial assembly 100 remotely via global positioning or a similar position locating technology.

The interactive memorial platform 240 further comprises a monitoring component access component 246 configured to access a monitoring component 150 of the interactive memorial assembly 100. The interactive memorial platform 240 further comprises an artificial intelligence (AI) component 250 configured to artificially age any uploaded digital content. This allows a user to view the decedent as they would look today based on uploaded imagery. The artificial intelligence program will perform multiple different functions, but will only have limited access to the products operating system, meaning that it will operate within the bounds of very specific parameters. It will be able to animate loved one's facial features in a variety of ways, such as diverse expressions, aging, and even speaking. The A.I. will also be able to assist users navigating the mobile application for more enabling a more user friendly platform.

The interactive memorial assembly 100 comprises a commemorative marker body 110. The commemorative marker body 110 comprises a top 112, a bottom 114, a pair of lateral sides 116, a front side 120, and a back side 118. The interactive memorial assembly 100 further comprises a display component 130 and a power component 160. The display component 130 is integrated into or attached to the front side 120 of the commemorative marker body 110. The display component 130 is waterproof or otherwise sealed into the commemorative marker body 110 for protection from the elements. The display component 130 comprises a touch screen 136. The touch screen 136 may be any interactive digital screen.

The display component 130 is in electrical communication with the power component 160 and further comprises a user input 138, a processor 132, and a memory 134. The display component 130 is configured to display digital content on the touchscreen 136 related to the decedent that is storable in the memory 134 or on the interactive memorial platform 240. The user input 138 is configured to allow a user to access stored digital content and to upload additional digital content to the display component 130. The display component 130 further comprises a communication link 140 operatively coupled to the processor 132 and the memory 134 for remotely accessing the interactive memorial assembly 100 on the mobile electronic device 210 via the network 220 using the mobile application 212.

The interactive memorial assembly 100 may further comprise an audio component 142. The audio component 142 may be one or more speakers operatively connected to the display component 130 to provide audio related to the digital content stored in the memory 134. The interactive memorial assembly 100 may further comprise a monitoring component 150. The monitoring component 150 may comprise a 360 degree rotating digital camera attachable to the top 112 of the commemorative marker body 110. The monitoring component 150 is in electrical communication with the display component 130 and the power component 160 and is remotely accessible via the monitoring component access component 246.

The power component 160 comprises a plurality of solar cells 162 and a rechargeable battery 164. The battery 164 is typically integrated into the commemorative marker body 110. The plurality of solar cells 162 are attachable to the back 118 or the sides 116 of the commemorative marker body 110, although they can be attached anywhere where it would be advantageous. The interactive memorial assembly 100 may further comprise a global positioning component 170. The global positioning component 170 is typically a GPS chip or transmitter that is attachable to or integrated into the commemorative marker body 110. The global positioning component 170 is powered by the power component 160 and is remotely accessible via the position locating component 248.

Notwithstanding the forgoing, the interactive digital memorial tombstone assembly 100 can be any suitable size, shape, and configuration as is known in the art without affecting the overall concept of the invention, provided that it accomplishes the above stated objectives. One of ordinary skill in the art will appreciate that the shape and size of the an interactive digital memorial tombstone assembly 100 and its various components, as show in the FIGS. are for illustrative purposes only, and that many other shapes and sizes of the interactive digital memorial tombstone assembly 100 are well within the scope of the present disclosure. Although dimensions of the interactive digital memorial tombstone assembly 100 and its components (i.e., length, width, and height) are important design parameters for good performance, the interactive digital memorial tombstone assembly 100 and its various components may be any shape or size that ensures optimal performance during use and/or that suits user need and/or preference. As such, the 100 may be comprised of sizing/shaping that is appropriate and specific in regard to whatever the interactive digital memorial tombstone assembly 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interactive memorial assembly comprising:
a commemorative marker body;
a display component integrated into the commemorative marker body;
a monitoring component attached to the commemorative marker body; and
a power component in electrical communication with the display component and the monitoring component.

2. The interactive memorial assembly of claim 1, wherein the commemorative marker body is transparent.

3. The interactive memorial assembly of claim 1, wherein display component is weatherproof.

4. The interactive memorial assembly of claim 1, wherein the display component comprises a user input.

5. The interactive memorial assembly of claim 1, wherein the display component comprises a touchscreen.

6. The interactive memorial assembly of claim 1, wherein the monitoring component is a rotating camera.

7. The interactive memorial assembly of claim 1, wherein the power component comprises a plurality of solar cells and a rechargeable battery.

8. The interactive memorial assembly of claim 1 further comprising a global positioning component in electrical communication with the power component.

9. An interactive memorial assembly comprising:
a commemorative marker body;
a display component comprising a touchscreen integrated into a front of the commemorative marker body;
a monitoring component attached to a top of the commemorative marker body;
a global positioning component integrated into the commemorative marker body; and
a solar power component in electrical communication with the display component, the monitoring component, and the global positioning component.

10. The interactive memorial assembly of claim 9, wherein the display component further comprises a user input integrated into the touchscreen.

11. The interactive memorial assembly of claim 9, wherein the monitoring component is a digital camera configured to rotate 360 degrees.

12. The interactive memorial assembly of claim 9, wherein the solar power component comprises a plurality of solar cells and a rechargeable battery.

13. The interactive memorial assembly of claim 9 further comprising at least one speaker in electrical communication with the display component.

14. An interactive memorial system accessible via a mobile electronic device comprising:
a server comprising an interactive memorial platform and at least one processor operatively connectable to the mobile electronic device via a network: and
wherein the interactive memorial platform is configured to allow a user to:
access an interactive memorial assembly remotely;
locate the interactive memorial assembly;
upload digital content related to a decedent; and
access digital content related to a decedent.

15. The interactive memorial system of claim 14, wherein the interactive memorial assembly comprises:
a commemorative marker body;
a display component integrated into the commemorative marker body;
a monitoring component attached to the commemorative marker body; and
a power component in electrical communication with the display component and the monitoring component.

16. The interactive memorial system of claim 15, wherein the interactive memorial platform is accessible via the mobile electronic device and the display component of the interactive memorial assembly.

17. The interactive memorial system of claim 15, wherein the interactive memorial platform is further configured to remotely access the monitoring component of the interactive memorial assembly.

18. The interactive memorial system of claim 17, wherein the interactive memorial platform is further configured to reposition the monitoring component of the interactive memorial assembly.

19. The interactive memorial system of claim 14, wherein the interactive memorial platform is further configured to locate a global position of the interactive memorial assembly.

20. The interactive memorial system of claim 14, wherein the interactive memorial platform is further configured to artificially age any uploaded digital content related to a decedent.
